(19) United States
(12) Patent Application Publication
(10) Pub. No.: US 2005/0162412 A1
(43) Pub. Date: Jul. 28, 2005

(54) Flat and extendable stylus

(75) Inventors: Antti Ronkko, Espoo (FI); Ilpo Kauhaniemi, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/766,519

(22) Filed: Jan. 28, 2004

(51) Int. Cl. G09G 5/00

(52) U.S. Cl. 345/179

(57) ABSTRACT

A stylus is presented, for physically contacting a touch-sensitive screen. The stylus includes a plurality of elements connected together by hinges or joints to form part of an accordion-style extendable instrument. The stylus also includes an additional element, connected to the rest of the accordion-style extendable instrument by at least one additional hinge or joint. The additional element has, or supports, a stylus tip for contacting the touch-sensitive screen.

### FIELD OF THE INVENTION

The present invention relates to touch-sensitive display screens, and more particularly to a stylus for touching a display screen.

### BACKGROUND OF THE INVENTION

Styluses have been around for millennia, for purposes of writing. They were used by the ancients for writing on wax tablets, and are used today for writing on touch-sensitive display screens. In both cases, the stylus is a pointed instrument that leaves no residue, such as ink residue left by a pen, or lead residue left by a pencil.

Unlike the wax tablets of ancient times, modern touch-sensitive display screens for mobile terminals are usually very small, and therefore it is advantageous to have a stylus that is small enough to be stored unobtrusively in the mobile terminal. It is known to use a pen cap having a pointed tip, for touching a display screen. It is also known to attach a stylus to one's finger as an extension, in much the same way that a tailor wears a thimble. Both of those devices can be seen at www.truetip.com.

However, the pen cap stylus requires that one have a pen or pencil on which to put the cap, and often a user of a display screen will not have a pen or pencil handy. Moreover, the small size of many display screens makes it impractical to store a pen, pencil, or rigid stylus in a mobile terminal having the display screen. Even if the stylus is designed like a telescope, so that it can collapse to a smaller size, still the storage requirements are excessive when the mobile terminal is very small.

A finger extension stylus does not solve the problem, because it must be used in a way that is very different from using a pen or pencil, and so using a finger extension would be disagreeable for many people who are unfamiliar with such a technique of writing. Moreover, using a finger extension will tend to block much of the display screen from view, because a typical human index finger is much wider than a typical pen or pencil.

In order to save space in small devices having display screens, it is known to store a stylus-writable screen in a position from which the stylus-writable screen can be retracted using an accordion-style retraction technique. See Dowling (U.S. patent application No. 20030050019). This type of accordion-style arrangement will be familiar to many people from an entirely different context: as a way of constructing a baby gate, in order to keep a toddler from moving into a hallway. Dowling uses the same type of accordion arrangement to connect a stylus-writable screen to another small device, such as personal digital assistant (PDA).

However, space-saving techniques like Dowling's have not eliminated bulky styluses. Dowling's accordion retraction technique is for making a peripheral available, and does not do anything to reduce the size of the peripheral itself.

### SUMMARY OF THE INVENTION

The present invention is based on the realization that accordion retraction techniques can be useful not just for retracting peripherals from a device having a touch-screen, but can also be used to configure one of those peripherals itself. A stylus having a retractable accordion configuration allows the extended stylus to be at least as narrow as a pen or pencil, while allowing the user to handle the stylus much as the user would handle a pen or pencil. At the same time, such a stylus can be folded into very small dimensions for storage in a device having the touch-screen feature. This extendable stylus provides the user with an option when the user does not have any other type of stylus handy, or the user can rely exclusively on this extendable stylus.

The present extendable stylus is very flat, and therefore it will negligibly interfere with the user's view of a display screen, when the user views the stylus from its side. The flatness has the additional advantage of consuming negligible storage space.

The present stylus is for physically contacting a touch-sensitive screen. The stylus includes a plurality of elements connected together by hinges or joints to form part of an accordion-style extendable instrument. The stylus also includes an additional element, connected to the rest of the accordion-style extendable instrument by at least one additional hinge or joint. The additional element has, or supports, a stylus tip for contacting the touch-sensitive screen.

### BRIEF DESCRIPTION OF THE DRAWINGS

FIG. 1 shows a flat and extendable stylus being used with a touch-sensitive screen.

FIG. 2 is an enlarged view of the extended stylus shown in FIG. 1, including elements having equal lengths.

FIG. 3 shows the stylus of FIG. 2 in a folded configuration.

FIG. 4 is a side view of the stylus in its folded configuration.

FIG. 5 shows a stylus in an extended configuration, having many elements of different lengths.

FIG. 6 illustrates the stylus of FIG. 5 in a substantially folded configuration.

### DETAILED DESCRIPTION OF THE PREFERRED EMBODIMENTS

Styluses are often space-demanding. The present invention discloses a stylus made with a scissors-type construction that makes it possible to store and hide the stylus in a very space-saving way. Flatness is a critical factor, especially in a watch-phone having a touch-screen. It is also possible to hide or store the stylus in a headset or some other wearable item. Automatic extension of the stylus is possible, using a spring, and the construction of the stylus enables the user to adjust the stylus height.

The best mode of the present invention is where the basic elements of the stylus are equal length. Another embodiment is where the basic elements have different lengths, so that it looks like a coin in a closed position. The scissors-type construction is known from other contexts (such as baby gates), but is new as a stylus construction.

The present stylus construction fulfills the “small when stored, big when used” criterion for mobile terminals and devices. The present stylus is especially useful for cases where flatness is critical.

Features of this invention include occupying a small storage space, being long and rigid when extended, and possibly having either manual or automatic extension. The automatic extension uses a simple spring, against which the stylus can be pushed into a folded storage configuration.

For watch phones and similar devices, where a touch-screen is used and space is a very critical factor, the present stylus will be useful. The stylus can be constructed from polymer instead of metal, which would a yield a reduction in the number of parts, as well as a softer surface and other design possibilities. It would be difficult to manufacture the present stylus from two molded parts with living hinges and connecting these two parts with rivets, because the stylus might not be rigid enough. However, it is possible to mold bars (i.e. individual elements) with metal inserts (shafts) and other bars with holes, so that each respective bar with a perpendicular shaft mates with a bar having a hole in which the shaft fits, in order to create pivoting (i.e. scissors) action.

A coating with some softer material to get a better feeling in use is possible, for example a coating on the elements' outer flat areas. Using a metal material has various benefits: more rigidity, possibly better function, potentially longer lifetime, and different decorative possibilities. In contrast, using a polymer material involves a simpler manufacturing process (less parts and processes), and is also less expensive to manufacture if the volume is over a certain limit. A polymer material offers the possibility that the user can snap elements of the stylus on and off, so as to alter the length of the stylus, and the elements can be available in different colors so that the user is able to choose one or more colors that are appealing to the user.

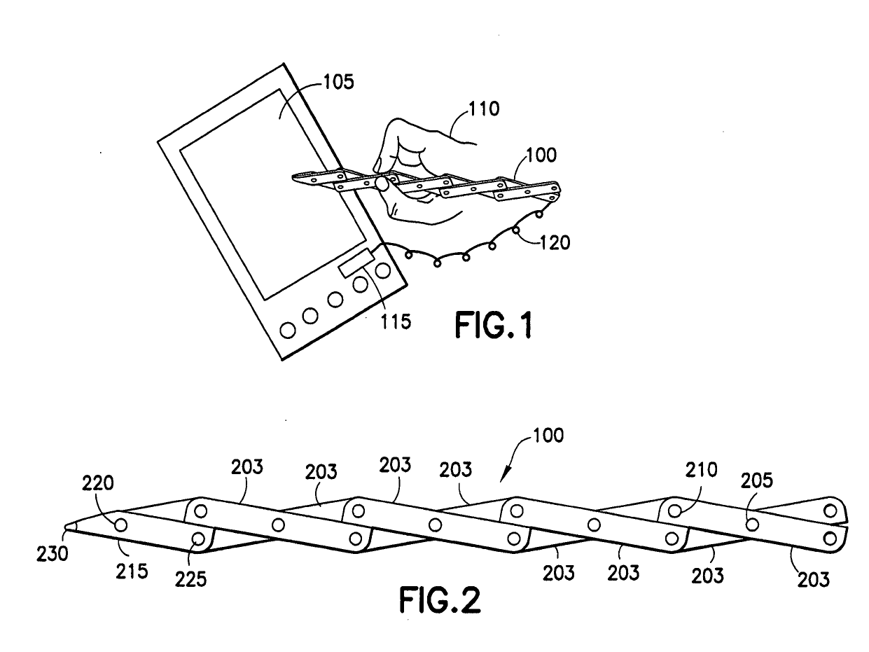

Turning now to FIG. 1, the stylus 100 is used for physically contacting a touch-sensitive screen 105, and the stylus is held in a user's hand 110 much as the user would hold a pen or pencil. FIG. 2 is an enlarged view of the stylus shown in FIG. 1.

As seen in FIG. 2, the stylus 100 includes a plurality of elements 203 connected together by hinges or joints to form part of an accordion-style extendable instrument. Each element has a pivot point 205, and at least one other joint or hinge 210. The stylus further includes an additional element 215 which is connected to the rest of the accordion-style extendable instrument by hinges or joints 220 and 225. The additional element 215 has (or supports) a stylus tip 230 for contacting the touch-sensitive screen. The stylus tip 230 is at a distal end of the additional element 215, and is extendable away from the plurality of other elements. The stylus tip 230 has a point that is sufficiently blunt to contact the touch-sensitive screen without scratching. As shown in FIG. 2, the plurality of elements 203 have equal lengths.

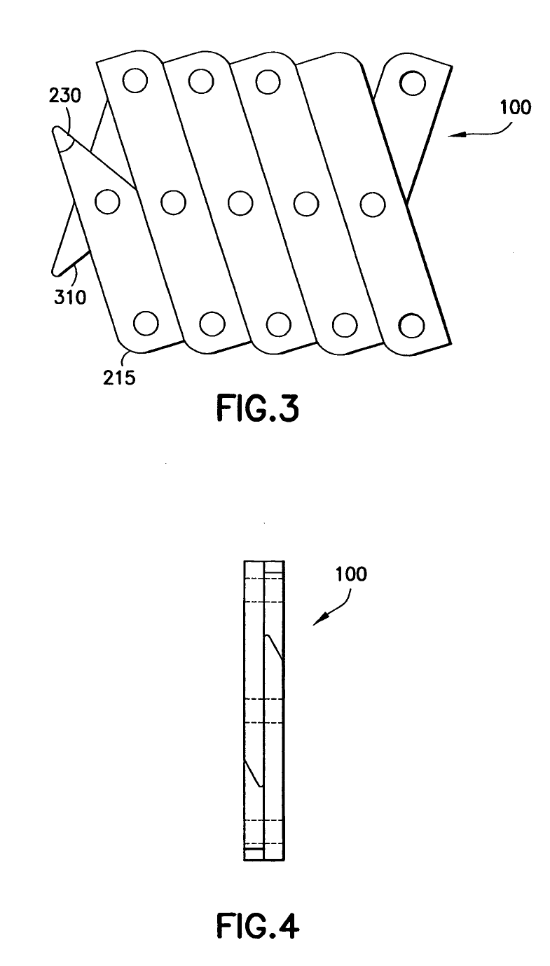

Turning now to FIG. 3, this shows the same stylus of FIGS. 1 and 2, except that the stylus is in its folded configuration in FIG. 3. The additional element 215 pivots with respect to one of the other elements 310, and preferably the tip 230 extends beyond and away from the element with which it pivots. That way, only one tip will contact the touch-sensitive screen, instead of two.

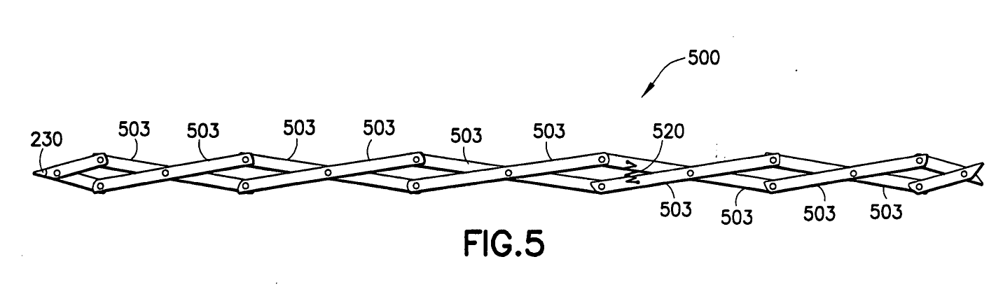

FIG. 4 is a side view of FIG. 3, which shows the very flat nature of the present stylus. Of course, the stylus will therefor also be very flat in its extended configuration, so its depth will be less than one quarter of a standard number two pencil's depth.

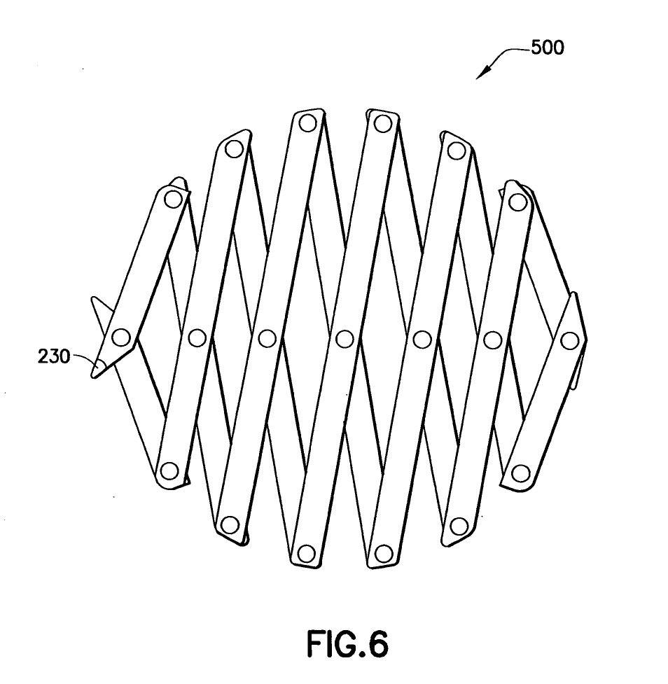

FIG. 5 shows a different embodiment of the stylus 500 according to the present invention. The spring 520 will pull the elements 503 together, thus causing the stylus to automatically extend. Also in FIG. 5, the plurality of elements 503 have various respective lengths, so that the stylus in a folded configuration has a substantially circular perimeter.

The circular perimeter is shown in FIG. 6. The stylus 500 may contain additional features, such as a button to activate the spring, and also a device such as a key to turn on a touch-screen (e.g. the key could be located at the part of the stylus most distant from the tip 230.

As seen in FIG. 1, the present invention also includes a mobile terminal having a touch-sensitive screen 105 and an accordion-style stylus 100, plus an enclosure 115 for storing the stylus in its folded configuration. In order to help ensure that the stylus will not get lost or otherwise separated from the mobile terminal, a tether 120 may be useful for tethering the stylus to the mobile terminal.

It is to be understood that all of the present figures, and the accompanying narrative discussions of the best mode embodiments, do not purport to be completely rigorous treatments of the invention under consideration. A person skilled in the art will understand that the structures described in this application can be implemented by a variety of different combinations of materials and in a variety of different ways, without departing from the spirit of the invention, which need not be further detailed herein.

1. A stylus for physically contacting a touch-sensitive screen, the stylus comprising:
a plurality of elements connected together by hinges or joints to form part of an accordion-style extendable instrument; and
an additional element, connected to the part of the accordion-style extendable instrument by at least one additional hinge or joint,
wherein the additional element has or supports a stylus tip for contacting the touch-sensitive screen.

2. The stylus of claim 1, wherein the stylus tip is at a distal end of the additional element, and is extendable away from the plurality of elements.

3. The stylus of claim 2, wherein the stylus tip has a point that is sufficiently blunt to contact the touch-sensitive screen without scratching.

4. The stylus of claim 1, wherein the plurality of elements mostly have substantially equal length.

5. The stylus of claim 1, wherein the plurality of elements have respective lengths so that the stylus in a folded configuration has a substantially circular perimeter.

6. The stylus of claim 1, further comprising a spring for automatically extending the stylus.

7. The stylus of claim 6, further comprising a button for activating the spring.

8. The stylus of claim 1, further comprising a touch-screen activation unit.

9. The stylus of claim 8, wherein the activation unit is a key.

10. The stylus of claim 1, having an extended configuration that is sufficiently flat so that the extended configuration has a depth less than one quarter of a standard number two pencil's depth.

11. A mobile terminal comprising:
a touch-sensitive screen;
a stylus having an accordion style; and
an enclosure for storing the stylus in a folded configuration.

12. The mobile terminal of claim 11, further comprising a tether for tethering the stylus to the mobile terminal.

13. The mobile terminal of claim 11, wherein the stylus comprises a mobile terminal activation unit.

14. The mobile terminal of claim 11, wherein the mobile terminal activation unit is a key.

15. An extendable accordion-style stylus comprising:
a plurality of elements;
a plurality of hinges or joints connecting the plurality of elements; and
a tip for contacting at least one part of a mobile terminal.
